(19) United States
(12) Patent Application Publication
(10) Pub. No.: US 2016/0070564 A1
(43) Pub. Date: Mar. 10, 2016

(54) DYNAMICALLY SCHEMATIZED LOG MESSAGES FOR SOFTWARE APPLICATIONS

(71) Applicant: Microsoft Corporation, Redmond, WA (US)

(72) Inventors: Yi-Lei Wu, Redmond, WA (US); Michael Christopher Cales, Redmond, WA (US)

(21) Appl. No.: 14/481,205

(22) Filed: Sep. 9, 2014

(51) Int. Cl. G06F 9/44; H04L 29/08

(52) U.S. Cl. CPC G06F 8/70; H04L 67/10

(57) ABSTRACT

Disclosed herein are systems, methods, and software to enhance log message handling. In an implementation, a message logging service receives log messages that fail to conform to a log schema. The service maps at least a subset of the log messages to a schematized log message that conforms to the log schema. The schematized log message can then be logged in a message log.

### TECHNICAL BACKGROUND

Many software applications are capable of logging information that may pertain to the operation or status of an application. A wide variety of log messages exist, including those that pertain to software exceptions, run-time errors, the status of resources, device failures, and other types of information.

The content of many log messages is usually determined by a developer, when code is being written. The content may be text given in free form such that it is easy for a person to read. A log message that can be easily consumed allows for efficient debugging when an application is in development and for trouble-shooting when deployed. However, the customization that is prevalent across log messages makes analyzing software operations difficult to do in a large scale, systematic manner.

In an example, some software applications are produced by large teams of developers, who might each produce log messages in different ways, with different content and formats. Thus, two applications or components may log the same information, but in different ways, which inhibits trouble-shooting and other analytical techniques.

The problem is compounded when applications are deployed at scale for large numbers of users. While in the past a log message might be created in an application intended for a relatively small-scale deployment, cloud-scale deployments involve many more instances of an application and a vastly increased volume of log messages. Making sense of the log messages in this context is increasingly difficult, yet important to the successful deployment of modern software deployments.

One approach that mitigates these and other frustrations involves harmonizing log messages across applications, components, and developers. Developers can be trained and even required to utilize a specific set of log messages that conform to a particular schema. In this manner, log messages that are kicked-off by any of a variety of applications or components can be collected and analyzed systematically.

Unfortunately, developers sometimes balk at having to write their log messages in accordance with a particular schema. While log messages that conform to a prescribed schema may improve attempts to systematically analyze them, they may not convey information in a sufficiently meaningful way for the developers or other engineers that may be involved in trouble-shooting a software deployment.

### Overview

Provided herein are systems, methods, and software to enhance log messages and their handling in general. In an implementation, a message logging service receives log messages that fail to conform to a log schema. The service maps at least a subset of the log messages to a schematized log message that conforms to the log schema. The schematized log message can then be logged in a message log.

In some implementations, the message logging service derives data points from the log messages and examines the data points for a data point pattern that matches at least one of various data point patterns in a message map. A schematized log message can be identified from the message map and logged accordingly.

In this manner, non-conforming log messages can be accommodated, while still allowing for systematic analysis and other benefits associated with log messages that adhere to a log schema.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture in an implementation.

FIG. 2 illustrates a message logging process in an implementation.

FIG. 3 illustrates an operational architecture in an implementation.

FIG. 4 illustrates a message logging process in an implementation.

FIG. 5 illustrates an operational scenario in an implementation.

FIG. 6 illustrates a data point map in an implementation.

FIG. 7 illustrates a message map in an implementation.

FIG. 8 illustrates a computing system suitable for implementing any of the applications, services, processes, and operational scenarios disclosed herein with respect to FIGS. 1-7 and discussed in the Technical Disclosure below.

### TECHNICAL DISCLOSURE

Implementations disclosed herein enable log messages to be schematized dynamically, thereby allowing developers to still largely customize their log messages, while retaining the ability to systematically analyze logs. When an application encounters a state, event, or some other trigger that results in a log message, a service receives the log message. The log message may be a non-conforming log message in that it does not conform to a log schema that would otherwise allow it to be processed systematically.

The service maps the log message or messages to a schematized log message that does conform to the log schema. The schematized log message may then be entered in a message log. The message log can be analyzed in a variety of ways, such as to detect operational trends with respect to an application or group of applications. The non-conforming log message could also be logged, possibly in the same or a different message log, or could simply be discarded or handled in some other manner.

A log schema may be a syntax, specification, or other construct that expresses what text to include in a log message and how to format or otherwise arrange the content. For example, a log schema may specify what text string to use to encode a particular error in a log message, as well as how to arrange the text string relative to certain values that may be available for inclusion in the text message. A set of log messages that all conform to a log schema may thus be analyzed coherently to discover trends or other operational aspects.

A non-conforming log message may be one that does not conform to a particular syntax, specification, or other such way in which a log schema may be expressed. It may be difficult to systematically analyze a group of non-conforming log messages when it is possible for two messages to describe the same operational state or event in different ways.

Accordingly, in some implementations log messages may be “schematized” by mapping or translating one or more non-conforming messages to a log message that does conform to a log schema. In some scenarios, a single non-conforming message is mapped to a single conforming message. However, it is also possible for multiple non-conforming messages to be mapped to a single conforming message. Still other variations and combinations are possible and may be considered within the scope of the disclosure.

Mapping log messages to schematized log messages in some scenarios may include deriving data points from the messages and examining the data points for at least one data point pattern that matches at least one of various data point patterns in a message map. The message map may include the data point patterns expressed in association with various schematized log messages.

In some implementations, deriving the data points from the plurality of log messages may include examining message attributes associated with each log message for an attribute pattern that matches at least one of various attribute patterns in a data point map. The data point map may include the attribute patterns expressed in association with a set of potential data points.

Log messages may be originated by any of a variety of messages sources, including client applications in communication with an application service, service applications that host the application service, and any other type of application. The applications communicate the log messages to the message logging service in response to an event, condition, state change, or other trigger that prompts an application to generate and senD a log message. Some scenarios may involve a set of applications in an application suite.

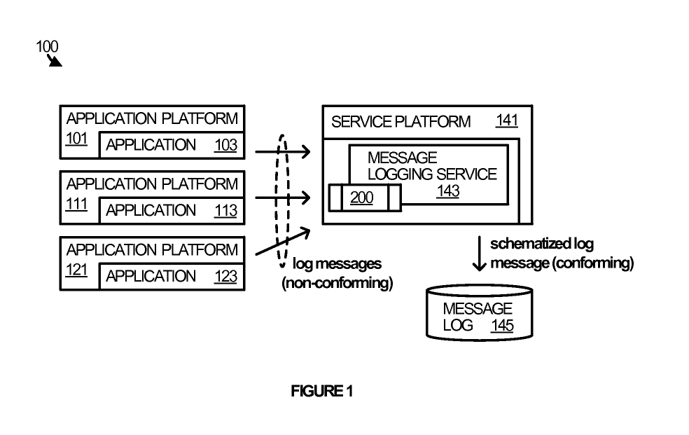

FIG. 1 illustrates an operational architecture 100 in an implementation of enhanced log message handling. Operational architecture 100 includes application platform 101, application platform 111, and application platform 121, on which application 103, application 113, and application 123 are each employed respectively. Operational architecture also includes service platform 141, which hosts message logging service 143.

In operation, applications 103, 113, and 123 from time to time communicate non-conforming log messages to message logging service 143. This may occur when, for example, one of the applications encounters a state, event, or some other condition that triggers a log message. Message logging service 143 receives the log messages and employs message logging process 200 to generate a schematized log message (or messages) for logging in message log 145.

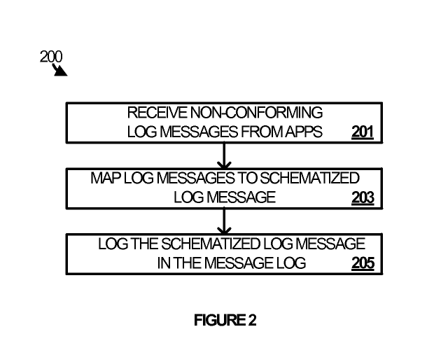

Message logging process 200, which is illustrated in more detail in FIG. 2, is representative of any process that may be employed by message logging service 143 to handle incoming log messages that may not conform to a log schema. It may be appreciated that other steps could be included in message logging process 200 in some implementations, and it is not limited to just those disclosed herein.

Referring parenthetically to the steps in message logging process 200, message logging service 143 receives non-conforming log messages from an application or applications (step 201). The applications may be client applications, service applications, or any other type of application. The log messages may be generated from a single application or multiple applications, and each application may communicate a single log message or multiple log messages.

Message logging service 143 maps the log message or messages to a schematized log message (step 203). In some cases, a single log message may be mapped to a single schematized log message. In other cases, multiple log messages may be mapped to a single schematized log message. In still other cases, multiple log messages may be mapped to multiple schematized log messages. Other variations and combinations of mapping are possible and may be considered within the scope of this disclosure.

Having mapped the log message or messages to a schematized log message, message logging service 143 logs the schematized log message in message log 145 (step 205). In some cases the non-conforming log messages may also be logged, possibly in message log 145 or some other log. Message log 145 can then be analyzed systematically to discover trends, assist with trouble-shooting, or the like.

Referring back to FIG. 1, application platforms 101, 111, and 121 are each representative of any physical or virtual computing system, device, or collection thereof capable of hosting an application, such as applications 103, 113, and 123 respectively. Examples include, but are not limited to, server computers, web servers, application servers, rack servers, blade servers, virtual machine servers, laptop computers, tablet computers, desktop computers, hybrid computers, smart phones, gaming machines, smart televisions, entertainment devices, and virtual machines, as well as any variation or combination thereof, of which computing system 801 in FIG. 8 is representative.

Applications 103, 113, and 123 are each representative of any application capable of communicating log messages to message logging service 143. Examples include, but are not limited to, word processing applications, spreadsheet applications, presentation applications, web browsers, email applications, blogging and micro-blogging applications, social networking applications, e-commerce applications, and gaming applications, as well as any other type of suitable application.

Service platform 141 is representative of any physical or virtual computing system, device, or collection thereof capable of hosting all or a portion of message logging service 143 and implementing all or portions of message logging process 200. Examples of service platform 141 include, but are not limited to, server computers, web servers, application servers, rack servers, blade servers, and virtual machine servers, as well as any other type of computing system, of which computing system 801 illustrated in FIG. 8 is representative. In some scenarios, service platform 141 may be implemented in a data center, a virtual data center, or some other suitable facility.

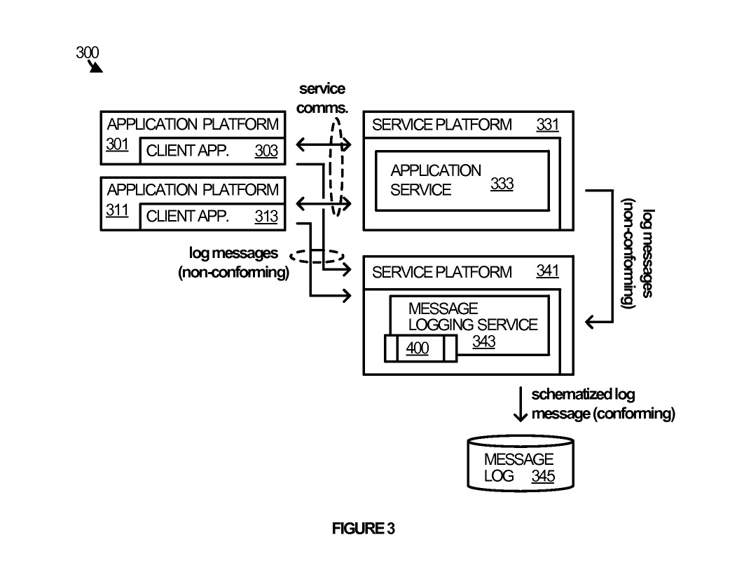

FIG. 3 illustrates an operational architecture 300 in an implementation of enhanced log message handling. Operational architecture 300 includes application platform 301, application platform 311, service platform 331, and service platform 341. Client application 303 and client application 313 run on application platform 301 and application platform 311 respectively. Application service 333 is hosted on service platform 331 and message logging service is hosted on service platform 341.

In operation, client applications 303 and 313 exchange service communications with application service 333 in order to provide a service to users associated with the client applications. Client applications 303 and 313 also communicate non-conforming log messages to message logging service 343. This may occur when, for example, one of the applications encounters a state, event, or some other condition that triggers a log message. Application service 333 may also communicate non-conforming log messages to message logging service 343.

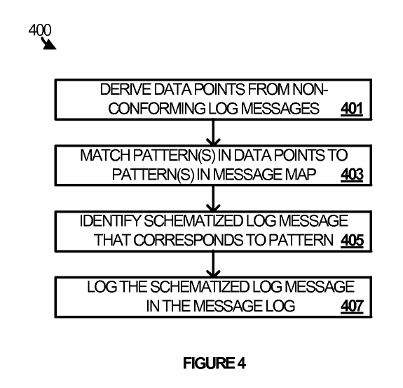

Message logging service 343 receives the log messages and employs message logging process 400 to generate a schematized log message or messages for logging in message log 345. Message logging process 400, which is illustrated in more detail in FIG. 4, is representative of any process that may be employed by message logging service 443 to handle incoming log messages that may not conform to a log schema. It may be appreciated that other steps could be included in message logging process 400 in some implementations, and it is not limited to just those disclosed herein.

Referring parenthetically to the steps in message logging process 400, message logging service 343 receives non-conforming log messages from any one or more of client applications 303 and 313 and application service 333 and derives data points from the messages (step 401). Message logging service 343 then matches A pattern or patterns in the data points to a pattern in a message map (step 403).

The message map may include various schematized log messages stored in corresponding association to various potential patternS. Various data structures other than a map may be used to associate schematized log messages with patterns, such as lists, graphs, arrays, or tables, as well as any combination or variation thereof. Message logging service 343 processes the map to identify a schematized log message that corresponds to the pattern derived from the data points (step 405). Once the schematized log message is identified, it can be stored in message log 345 (step 407). Message log 345 can then be analyzed systematically to discover trends, assist with trouble-shooting, or the like.

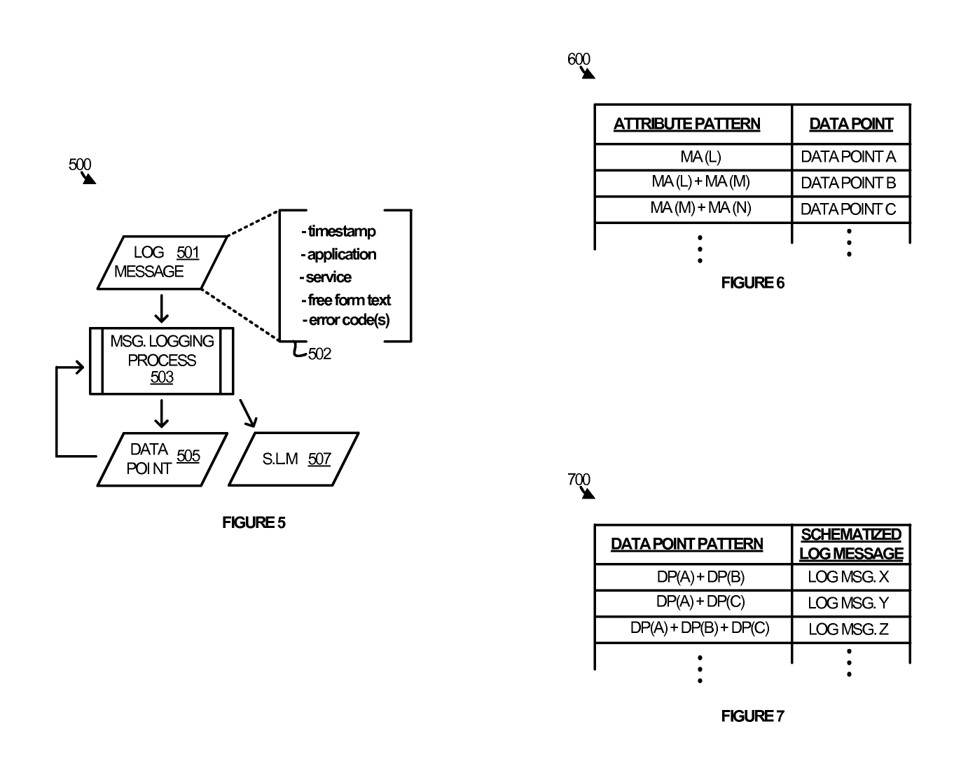

FIG. 5 illustrates an operational scenario 500 that demonstrates enhanced log message handling for data points in an implementation. In operation, a message logging service receives a log message 501. The log message 501 includes various message attributes 502, such as a timestamp, application information, service information, free-form text, and an error code. Other attributes in addition to or in place of those disclosed herein may be considered within the scope of the present disclosure.

A timestamp attribute may indicate the date and time that a log message is sent. Application information may identify the application that is the source of a log message. Service information may identify the service that is the source of the log message. Free-form text may describe the particular state, event, or other such condition that triggers a log message. An error code may be codified text that represents a particular state, event, or other such condition that triggers a log message.

These and other possible attributes are examined by message logging process 503 to identify data points. Message logging process 503 is representative of message logging process 200 and message logging process 400 discussed above. Message logging process 503 considers message attributes 502 in order to identify data point 505. This is accomplished by comparing a message attribute pattern or patterns in message attributes 502 to patterns in a data point map. A message attribute pattern can be compared to the patterns in the data point map to identify a data point that can be extracted from a log message.

Message logging process 503 takes a resulting data point or data points and examines them to determine if a data point pattern exists that matches one in a message map. The message map associates data point patterns to schematized log messages. A data point pattern could be formed by a single data point or multiple data points. Thus, message logging process 503 may operate recursively on multiple log messages, extracting data points from the log messages and examining them for data point patterns that map to schematized log messages. Eventually a data point pattern may be discovered that maps to a particular schematized log message and the schematized log message 507 can be generated and logged in a log system. The process may operate on a continuous basis as log messages arrive, allowing for the continuous generation and logging of schematized log messages.

FIG. 6 illustrates a data point map 600 that is representative of a map that message logging process 503 may access when handling log messages. Data point map 600 includes one column that lists various message attribute patterns. Another column lists various data points that correspond to the message attribute patterns. For instance, a pattern that includes message attribute L maps to data point A; a pattern that includes message attributes L and M maps to data point B; and a pattern that includes message attributes M and N maps to data point C.

As a log message is processed, its message attributes are examined for any individual attribute or group of attributes that match a pattern in data point map 600. For example, a message that arrives from a particular service may match a pattern. As such, a corresponding data point can be recorded. In another example, a message that arrives from a specific application and that contains a particular string in its free-form text can result in a data point.

Data point map 600 may be programmed with various message attribute patterns and their corresponding data points. However, in some scenarios data point map 600 may be dynamically updated as new message attribute patterns are discovered or old message attributes are retired. Such dynamic updating could happen automatically, manually, or in any combination or variation thereof.

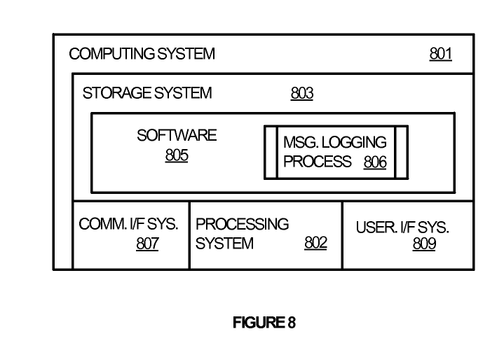

The data points discovered by message logging process 503 are recorded and evaluated for data point patterns that map to schematized log messages. Message map 700 in FIG. 7 is representative of a message map that can be utilized to map data points to schematized log message.

Message map 700 includes two columns: one column that lists various data point patterns and a second column that lists their corresponding schematized log messages. For instance, a data point pattern that includes data point A and data point B maps to schematized log message X; a data point pattern that includes data point A and data point C maps to schematized log message Y; and a data point pattern that includes data point A, data point B, and data point C maps to schematized log message Z.

In an example, data point A may have been recorded in response to a log message that arrived from a particular service, as indicated by its service attribute. Data point B may have been recorded in response to a log message arriving from a particular application and that contains a particular string in its free-form text. The combination of the two data points results in the generation and logging of schematized log message X.

The two data points A and B may have been generated in response to the arrival of a single log message that included all three attributes: the relevant service, the relevant application association, and the relevant free-form text. Thus an individual non-conforming log message could result in an individual schematized log message being generated and logged.

However, it is also possible that the two data points may have been generated in response to multiple log messages. For instance, one log message could have arrived from a particular service, resulting in data point A, while another log message could have arrived from a particular application and including specific text, resulting in data point B. The creation of the two data points from two incoming log messages can result in the generation of an individual schematized log message X.

It may be appreciated in the foregoing examples discussed with respect to FIG. 6 and FIG. 7 that time may be one constraint that is considered when searching for patterns. For example, the message attribute pattern for data point B in data point map 600 may include the constraint that message attribute L and message attribute M be identified or occur within a specified time window. In another example, the data point pattern for schematized log message Z may include the constraint that data point A, data point B, and data point C be identified or occur specified a particular time window. The timestamp attribute associated with each log message can be used to assist with such analysis. However, timestamps may also be recorded in association with the message attributes as they are identified, the data points as they are identified, or both.

Referring back to FIG. 3, application platforms 301 and 311 are each representative of any physical or virtual computing system, device, or collection thereof capable of hosting an application, such as client applications 303 and 313 respectively. Service platform 331 is representative of any physical or virtual computing system, device, or collection thereof capable of hosting an application service, such as application service 333. Service platform 341 is representative of any physical or virtual computing system, device, or collection thereof capable of hosting message logging service 343. Computing system 801 in FIG. 8 is representative of any computing system suitable for implementing the aforementioned application platforms and service platforms.

Client applications 303 and 313 are each representative of any client application capable of interacting with application service 333 and communicating log messages to message logging service 343. Examples include, but are not limited to, word processing applications, spreadsheet applications, presentation applications, web browsers, email applications, blogging and micro-blogging applications, social networking applications, e-commerce applications, and gaming applications, as well as any other suitable application.

Application service 333 is representative of any service capable of interacting with client applications 303 and 313 and communicating log messages to message logging service 343. Examples of application service 333 include, but are not limited to, office productivity services, email services, search services, e-commerce services, gaming services, information technology services, media services, and any other type of service.

FIG. 8 illustrates a computing system 801 that is representative of any computing systems or systems with which the various operational scenarios and processes disclosed herein may be implemented. Examples of computing system 801 include, but are not limited to, server computers, web servers, application servers, rack servers, blade servers, virtual servers, desktop computers, work stations, laptop computers, tablet computers, smart phones, hybrid computers, gaming machines, virtual machines, smart televisions, and watches and other wearable devices, as well as any variation or combination thereof. In some implementations, a collection of multiple computing systems may be employed to implement all or portions of an application or service which may be hosted in one or more data centers, virtual data centers, or any other suitable computing facilities.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. When executed by processing system 802 to implement enhanced log message handling, software 805 directs processing system 802 to operate as described herein for the various processes, operational scenarios, and sequences discussed in the foregoing implementations. Computing system 801 may optionally include additional devices, features, or functionality not discussed for purposes of brevity.

Referring still to FIG. 8, processing system 802 may comprise a microprocessor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 includes message logging process 806, which is representative of message logging processes 200, 400, and 503. Software 805 in general, and message logging process 806 in particular, may be implemented in program instructions that among other functions may, when executed by processing system 802, direct processing system 802 to operate as described with respect to the various operational scenarios, sequences, and processes illustrated herein.

The program instructions may include various components or modules that cooperate or otherwise interact to carry out the various processes and operational scenarios described herein. The various components or modules may be embodied in compiled or interpreted instructions or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to facilitate enhanced log message handling. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

It may be understood that computing system 801 is generally intended to represent a computing system or systems on which software 805 may be deployed and executed in order to implement message logging process 806. However, computing system 801 may also be suitable as any computing system on which software 805 may be staged and from where one or both may be distributed, transported, downloaded, or otherwise provided to yet another computing system for deployment and execution, or yet additional distribution.

Communication interface system 807 may include communication connections and devices that allow for communication with other computing systems over a communication network. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface. In addition, user input made with respect to the user interfaces can be input via user interface system 809.

Communication between computing system 801 and any other computing system may occur over a communication network or networks and in accordance with various communication protocols, combinations of protocols, or variations thereof. Examples of such communication networks include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which information is exchanged, the exchange of information may occur in accordance with any of a variety of protocols, including FTP (file transfer protocol), HTTP (hypertext transfer protocol), HTTPS (HTTP secure), SOAP (simply object access protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

While FIGS. 1-8 generally depict relatively few users and relatively few instances of service platforms, application platforms, applications, and services, it may be appreciated that the concepts disclosed herein may be applied at scale. For example, the message logging processes disclosed herein could be deployed in support of any number of applications, services, and instances thereof.

Various technical effects may be appreciated from the foregoing implementations. The ability to generate schematized log messages allows developers to continue using non-conforming log messages. Non-conforming log messages may provide greater utility to a developer for their ability to communicate customized information, while schematized log messages allow for systematic analysis of logs. In addition, schematizing log messages may reduce the quantity of messages that are logged, which is beneficial in view of the scale at which many applications are deployed. A reduced set of log messages saves storage resources and processing resources. Schematizing log messages also allows log messages from a diverse set of applications to be analyzed in a unified manner.

Various improvements to message logging technology may also be appreciated from the foregoing implementations. Past logging technology asked developers to conform to strict logging schema in order to support logging and analysis. The message logging processes and other subject matter disclosed herein improves such technology by allowing developers to write free-form content in log messages. Such non-conforming messages can be turned into a conforming, schematized log message.

Certain inventive aspects may be appreciated from the foregoing disclosure, of which the following are various examples.

### EXAMPLE 1

A method of operating a message logging service, the method comprising receiving a plurality of log messages that fail to conform to a log schema; mapping at least a subset of the plurality log messages to at least a schematized log message that conforms to the log schema; and logging at least the schematized log message in a message log.

### EXAMPLE 2

The method of Example 1 wherein mapping at least the subset of the plurality of log messages to at least the schematized log message comprises deriving a plurality of data points from the plurality of log messages; and examining the plurality of data points for at least a data point pattern that matches at least one of a plurality of data point patterns in a message map, wherein the message map comprises the plurality of data point patterns expressed in association with a plurality of schematized log messages.

### EXAMPLE 3

The method of Examples 1-2 wherein deriving the plurality of data points from the plurality of log messages comprises, for each log message of the plurality of log messages, examining a plurality of message attributes associated with the log message for an attribute pattern that matches at least one of a plurality of attribute patterns in a data point map, wherein the data point map comprises the plurality of attribute patterns expressed in association with a plurality of potential data points.

### EXAMPLE 4

The method of Examples 1-3 wherein receiving the plurality of log messages comprises receiving the plurality of log messages from a plurality of applications that originate the plurality of log messages.

### EXAMPLE 5

The method of Examples 1-4 wherein each of the plurality of applications comprises one of a set of applications in an application suite.

### EXAMPLE 6

The method of Examples 1-5 wherein the plurality of applications comprises a plurality of client applications in communication with an application service.

### EXAMPLE 7

The method of Examples 1-6 wherein the plurality of applications further comprises a plurality of service applications that host the application service.

### EXAMPLE 8

One or more computer readable storage media having program instructions stored thereon for operating a message logging service that, when executed by a computing system, direct the computing system to at least: receive a plurality of log messages that fail to conform to a log schema; map at least a subset of the plurality log messages to at least a schematized log message that conform to the log schema; and log at least the schematized log message in a message log.

### EXAMPLE 9

The one or more computer readable storage media of Example 8 wherein mapping at least the subset of the plurality of log messages to at least the schematized log message comprises: deriving a plurality of data points from the plurality of log messages; and examining the plurality of data points for at least a data point pattern that matches at least one of a plurality of data point patterns in a message map, wherein the message map comprises the plurality of data point patterns expressed in association with a plurality of schematized log messages.

### EXAMPLE 10

The one or more computer readable storage media of Examples 8-9 wherein, to derive the plurality of data points from the plurality of log messages, the program instructions direct the computing system to, for each log message of the plurality of log messages, examine a plurality of message attributes associated with the log message for an attribute pattern that matches at least one of a plurality of attribute patterns in a data point map, wherein the data point map comprises the plurality of attribute patterns expressed in association with a plurality of potential data points.

### EXAMPLE 11

The one or more computer readable storage media of Examples 8-10 wherein, to receive the plurality of log messages, the program instructions direct the computing system to receive the plurality of log messages from a plurality of applications that originate the plurality of log messages.

### EXAMPLE 12

The one or more computer readable storage media of Examples 8-11 wherein each of the plurality of applications comprises one of a set of applications in an application suite.

### EXAMPLE 13

The one or more computer readable storage media of Examples 8-12 wherein the plurality of applications comprises a plurality of client applications in communication with an application service.

### EXAMPLE 14

The one or more computer readable storage media of Examples 8-13 wherein the plurality of applications further comprises a plurality of service applications that host the application service.

### EXAMPLE 15

An apparatus comprising one or more computer readable storage media; and program instructions stored on the one or more computer readable storage media that, when executed by a processing system, direct the processing system to at least: derive at least a plurality of data points from a plurality of log messages received from a plurality of applications; examine the plurality of data points for at least a data point pattern that matches at least one of a plurality of data point patterns in a message map that comprises the plurality of data point patterns expressed in a corresponding association with a plurality of schematized log messages; and log at least a schematized log message in a message log that corresponds to the one of the plurality of data point patterns in the message map.

### EXAMPLE 16

The apparatus of Example 15 further comprising the processing system, wherein each of the plurality of log messages fail to conform to a log schema, and wherein each of the plurality of schematized log messages conform to the log schema.

### EXAMPLE 17

The apparatus of Examples 15-16 wherein to derive the plurality of data points from the plurality of log messages, the program instructions direct the processing system to, for each log message of the plurality of log messages, examine a plurality of message attributes associated with the log message for an attribute pattern that matches at least one of a plurality of attribute patterns in a data point map, wherein the data point map comprises the plurality of attribute patterns expressed in association with a plurality of potential data points.

### EXAMPLE 18

The apparatus of Examples 15-17 wherein the plurality of applications that originate the plurality of log messages and wherein each of the plurality of applications comprises one of a set of applications in an application suite.

### EXAMPLE 19

The apparatus of Examples 15-18 wherein the plurality of applications that originate the plurality of log messages and wherein the plurality of applications comprises a plurality of client applications in communication with an application service.

### EXAMPLE 20

The apparatus of Examples 15-19 wherein the plurality of applications further comprises a plurality of service applications that host the application service.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a message logging service, the method comprising:
receiving a plurality of log messages that fail to conform to a log schema;
mapping at least a subset of the plurality log messages to at least a schematized log message that conforms to the log schema; and
logging at least the schematized log message in a message log.

2. The method of claim 1 wherein mapping at least the subset of the plurality of log messages to at least the schematized log message comprises:
deriving a plurality of data points from the plurality of log messages; and
examining the plurality of data points for at least a data point pattern that matches at least one of a plurality of data point patterns in a message map, wherein the message map comprises the plurality of data point patterns expressed in association with a plurality of schematized log messages.

3. The method of claim 2 wherein deriving the plurality of data points from the plurality of log messages comprises, for each log message of the plurality of log messages, examining a plurality of message attributes associated with the log message for an attribute pattern that matches at least one of a plurality of attribute patterns in a data point map, wherein the data point map comprises the plurality of attribute patterns expressed in association with a plurality of potential data points.

4. The method of claim 1 wherein receiving the plurality of log messages comprises receiving the plurality of log messages from a plurality of applications that originate the plurality of log messages.

5. The method of claim 4 wherein each of the plurality of applications comprises one of a set of applications in an application suite.

6. The method of claim 4 wherein the plurality of applications comprises a plurality of client applications in communication with an application service.

7. The method of claim 6 wherein the plurality of applications further comprises a plurality of service applications that host the application service.

8. One or more computer readable storage media having program instructions stored thereon for operating a message logging service that, when executed by a computing system, direct the computing system to at least:
receive a plurality of log messages that fail to conform to a log schema;
map at least a subset of the plurality log messages to at least a schematized log message that conform to the log schema; and
log at least the schematized log message in a message log.

9. The one or more computer readable storage media of claim 8 wherein mapping at least the subset of the plurality of log messages to at least the schematized log message comprises:
deriving a plurality of data points from the plurality of log messages; and
examining the plurality of data points for at least a data point pattern that matches at least one of a plurality of data point patterns in a message map, wherein the message map comprises the plurality of data point patterns expressed in association with a plurality of schematized log messages.

10. The one or more computer readable storage media of claim 9 wherein, to derive the plurality of data points from the plurality of log messages, the program instructions direct the computing system to, for each log message of the plurality of log messages, examine a plurality of message attributes associated with the log message for an attribute pattern that matches at least one of a plurality of attribute patterns in a data point map, wherein the data point map comprises the plurality of attribute patterns expressed in association with a plurality of potential data points.

11. The one or more computer readable storage media of claim 8 wherein, to receive the plurality of log messages, the program instructions direct the computing system to receive the plurality of log messages from a plurality of applications that originate the plurality of log messages.

12. The one or more computer readable storage media of claim 11 wherein each of the plurality of applications comprises one of a set of applications in an application suite.

13. The one or more computer readable storage media of claim 11 wherein the plurality of applications comprises a plurality of client applications in communication with an application service.

14. The one or more computer readable storage media of claim 13 wherein the plurality of applications further comprises a plurality of service applications that host the application service.

15. An apparatus comprising:
one or more computer readable storage media; and
program instructions stored on the one or more computer readable storage media that, when executed by a processing system, direct the processing system to at least:
derive at least a plurality of data points from a plurality of log messages received from a plurality of applications;
examine the plurality of data points for at least a data point pattern that matches at least one of a plurality of data point patterns in a message map that comprises the plurality of data point patterns expressed in a corresponding association with a plurality of schematized log messages; and
log at least a schematized log message in a message log that corresponds to the one of the plurality of data point patterns in the message map.

16. The apparatus of claim 15 further comprising the processing system, wherein each of the plurality of log messages fail to conform to a log schema, and wherein each of the plurality of schematized log messages conform to the log schema.

17. The apparatus of claim 16 wherein to derive the plurality of data points from the plurality of log messages, the program instructions direct the processing system to, for each log message of the plurality of log messages, examine a plurality of message attributes associated with the log message for an attribute pattern that matches at least one of a plurality of attribute patterns in a data point map, wherein the data point map comprises the plurality of attribute patterns expressed in association with a plurality of potential data points.

18. The apparatus of claim 15 wherein the plurality of applications that originate the plurality of log messages and wherein each of the plurality of applications comprises one of a set of applications in an application suite.

19. The apparatus of claim 15 wherein the plurality of applications that originate the plurality of log messages and wherein the plurality of applications comprises a plurality of client applications in communication with an application service.

20. The apparatus of claim 19 wherein the plurality of applications further comprises a plurality of service applications that host the application service.
